(19) United States
(12) Patent Application Publication
(10) Pub. No.: US 2010/0160056 A1
(43) Pub. Date: Jun. 24, 2010

(54) Golf tournament

(76) Inventor: Mark Dolling Andrews, Auckland (NZ)

Correspondence Address: Mark Dolling Andrews, 704 Remuera Road, Remuera, Auckland, 1050, omitted

(21) Appl. No.: 12/642,857

(22) Filed: Dec. 21, 2009

(30) Foreign Application Priority Data
Dec. 19, 2008 (NZ) 564720

(51) Int. Cl. A63B 71/00; G06F 19/00

(52) U.S. Cl. 473/131; 700/91

(57) ABSTRACT

A method for organising a golf tournament is described, the method comprising the steps of: specifying a first set of clubs for use in the tournament, said first set of clubs being designated traditional clubs. The method further comprising requiring each player to use said first set of clubs in at least one round of the tournament. In other rounds of the tournament each player can choose the golf clubs to use within the rules of golf.

### FIELD OF THE INVENTION

The present invention relates to methods for tournaments, and more particularly to methods for staging golf tournaments and even more particularly to methods for staging golf tournaments using both traditional and technological advanced golf balls and golf clubs.

### BACKGROUND OF THE INVENTION

Golf is a very popular sport world wide and has a long tradition. Most golf tournaments use the number of strokes that a player utilises to complete a number of holes to score the game. Another common alternative is to use the number of holes won by a player, often called match play, to score the game. Other formats such as scramble, where the best shot following every stroke is played by all members of the team are also possible. Various other alternatives are Best Ball, Alternative Shot, Modified Stable Ford, Chapman (Pinehurst), Pingo Bongo, Flags, Lone Ranger (Money Ball, Yellow Ball or Pink Ball), Peoria System and Galloway System.

One of the problems with the modern golf game is the technology used. Both golf clubs golf and balls are becoming so advanced that players are able to hit the ball further then they have traditionally been able to, which has led to a number of issues which are difficult to reconcile. Geoff Oglivy the winner of a recent US Open has said that:
‘technology has drastically changed the game, changed the world's greatest courses, rendered some redundant, and diminished the game's entertainment value’ as reported in Sunday Times 2007.

Many other industry observes including the regulatory bodies governing the game of golf see the de-skilling of the game as a significant problem. In February 2006 on the report of Equipment Standards Committee to the 2006 USGA Annual Meeting Jim Vernon, Chairman of the Committee said:
‘Indeed while distance certainly remains an issue, it is part of a broader change in the way the game is being played, what some are describing as the de-skilling of the game at the elite level.’
‘It is not just that driving distances have increased among elite players. What I am suggesting is that we need to reframe the discussion of how the game is played.

How do you fit this new game with new technology onto old golf courses? The issue is caused by the modern game's long hitters who regularly strike balls 300 yards off the tee. One solution has been to lengthen golf courses or to make the golf course conditions much more challenging which has in turn, lead to the alteration of the applicable golf course layout.

The USGA in ‘conjunction’ with other regulatory bodies are continuing an evaluation of the issues and whether it would be appropriate to require elite players to regain some of the skills that were more important in the past. As a result of the evaluation rule changes have been implemented, and the USGA and R&A have changed the rules placing restrictions on the cross sectional area and edge sharpness of golf club grooves. The new rules are designed to restore the challenge of playing shots to the green from the rough by reducing backspin on those shots. The rules limit clubs to having V shaped groves.

As Mr Vemon also comments:

“There are a lot of pieces to the puzzle . . . the talk is complicated, of course . . . we regulate for all golfers of all skill levels, not just PGA Tour professionals . . . we also are mindful of the Statement of Principles: that increased distance has other negative ramifications that we seek to avoid . . . the lengthening and toughening of courses is response to increase in distance is costly and in many cases, impossible. It also has negative effects on environmental and ecological issues, on the costs of maintaining courses and on the price of play as well”.

This is distracting from golf as a spectacle and the golfing industry. Both the Royal Ancient and the United States Golf Organisations have established rules and been trying to limit what balls and clubs can do and to limit the length of ball being hit and the degree of spin a ball may have.

The advancement in clubs and balls has benefited the recreational player to the extent they can go out and enjoy a game and still face challenges but feel better about driving the balls further than they have previously been able to. In the professional game and for highly skilled players however, the ability to drive the balls long distances is distracting from the other skills of the game such as chipping, putting and other strategic skills that win tournaments. The industry has sought to limit the technological advances in both clubs and in balls. What is desirable is to find a method and system to enable a more competitive and entertaining game to be played between professionals and highly skilled players while allowing advances that benefit amateur players. The proposed methodology would be available to players of lesser skill, if they so chose to do so thereby meeting a key USGA criteria of regulations equipment for all golfers of all skill levels, not just PGA Tour professionals.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

The present invention relates to a method for a golf tournament that enhances the entertainment value of the event by requiring the use of novel equipment and novel rules but at least provides the public or industry with a useful choice.

In a first embodiment the present invention consists of a method for organising a golf tournament comprising the steps of:

specifying a first set of clubs for use in the tournament, said first set of clubs being designated traditional clubs;

requiring each player to use said first set of clubs in at least one round of the tournament;

wherein in other rounds of the tournament each player can choose the golf clubs to use within the rules of golf.

Preferably the step of requiring each player to use said first set of clubs in at least one round of the tournament requires the player to use the first set of clubs in at least two rounds of said tournament.

Preferably each player is required to use said first set of clubs in one round of the first two rounds of the tournament and one round of the third and fourth rounds of the tournament.

Preferably during the tournament each player is required to use a first specified ball for a least one round of the tournament, said specified ball being of a limited nature.

Preferably during the tournament each player is required to use said first ball when using said first clubs.

Alternatively during the tournament each player is required to use said first ball when not using said first clubs.

Alternatively during the tournament each player is required to use balls of a type other than said first ball when not using said first clubs.

Preferably the combination of balls and clubs are specified for at least one of the rounds of the tournament (the specified combination).

Preferably the choice of at least one round to use said specified combination is left to the player.

Alternatively the specified combination is played in a specified round.

Alternatively the choice of the at least one round to use said specified combination is selected from a specified plurality of rounds.

Preferably there is more than one specified combination; each said combination required to be used for a specified number of rounds.

Preferably each said player tees off a first set of tees when using said first clubs and a second set of tees when using other clubs, said first set of tees resulting in shorter holes.

Alternatively only one set of tees would be used.

In a second embodiment the present invention consists of a method for organising a golf tournament comprising the steps of:

specifying a first set of balls for use in the tournament, said first set of balls being designated limited balls; and

requiring each player to use said first set of balls in at least one round of the tournament;

wherein in other rounds of the tournament each player can choose the golf balls to use within the rules of golf.

In a third embodiment the present invention consists of a computer programmed to organise a golf tournament, said computer programmed to: decide on the combination of clubs and ball each player is to use in each round of said tournament, said clubs being selected from those designated traditional clubs; and those designated modern clubs, said ball being selected from those designated traditional style balls and modern style balls.

### BRIEF DESCRIPTION OF THE DRAWINGS

FIG. 1 is a flow diagram of the golf tournament round of the present invention.

FIG. 2 is an illustration of a computer suitable for implementing the present invention

### DETAILED DESCRIPTION

The present invention provides a system and method for staging a golf tournament that provides greater entertainment for tournament viewers and an increased challenge for the tournament competitors and resolve issues of distance.

In a preferred mode of the invention, two sets of clubs and two sets of balls are used.

The first set of clubs would be limited in their technological design. They may be called traditional or other clubs having restricted technological features. For example, traditionally irons had V groves. Therefore, one restriction may be limiting all the traditional clubs to having V groves. It is envisaged that clubs would have certain restrictions on their ability both to hit the ball, to spin the ball and various other features. The second set of clubs can be described as technological advanced or the best clubs that club manufactures can produce within the rules of the game.

For example the USGA Interim Report on Spin Generation published Aug. 7, 2006 discusses the use of clubs having traditional V shaped groves vs. clubs having the newer U shaped groves. Rules changes have been implemented as a result of the report, and the USGA and R&A have changed the rules placing restrictions on the cross sectional area and edge sharpness of golf club grooves. The new rules are designed to restore the challenge of playing shots to the green from the rough by reducing backspin on those shots. The rules limit clubs over a specified loft to having V shaped groves.

In one embodiment the present invention anticipates the best technologically advanced clubs available at the time being used and the older clubs being used as the clubs have restricted technological features.

The two balls used for the tournament will again be called “technologically advanced balls” and “limited balls”. It is envisaged that the technologically advanced balls will be best balls that a manufacturer could manufacture within the rules of the game. The limited or traditional style balls would have limited characteristics such as the spin and the distance that they could travel. In one embodiment the modern ball used would be one with a urethane cover commonly known as a urethane three piece ball (U3P).

In an alternate embodiment only one ball would be used for the tournament, either a limited ball or a technologically advanced ball.

The scoring could follow any one of a number of traditional and conventional play scoring rules. However, a player may or would have to choose between the traditional and modern clubs and balls. It is anticipated that during the first two rounds of the tournament, the player for one of the rounds would have to use the traditional clubs and for one of the rounds would have to use the traditional balls. In the second two rounds of the tournament, the player would have to use the traditional clubs for one round and the traditional balls for one round.

Alternatively during the whole tournament only one round may need to be played with traditional clubs. The round to be played could be either selected by the tournament organisers or left for the players to decide. If the tournament organisers decide they may still leave some freedom for the players, such that the organisers may specify that the traditional round must be selected from a limit number of rounds, for example the traditional round must be selected from the first three rounds.

While it is anticipated the player would use the traditional clubs and balls together or modern clubs and advanced ball together, it is possible that a player could use traditional balls with a modern clubs and the advanced balls with the traditional clubs. Also anticipated is the use of only one ball either a limited ball or a technologically advanced ball.

The present invention has the advantage of bringing the golf tournament game with golf professionals back to an interesting and competitive environment. The players' short game and accuracy would become just as important again as the ability to power the ball through long distances.

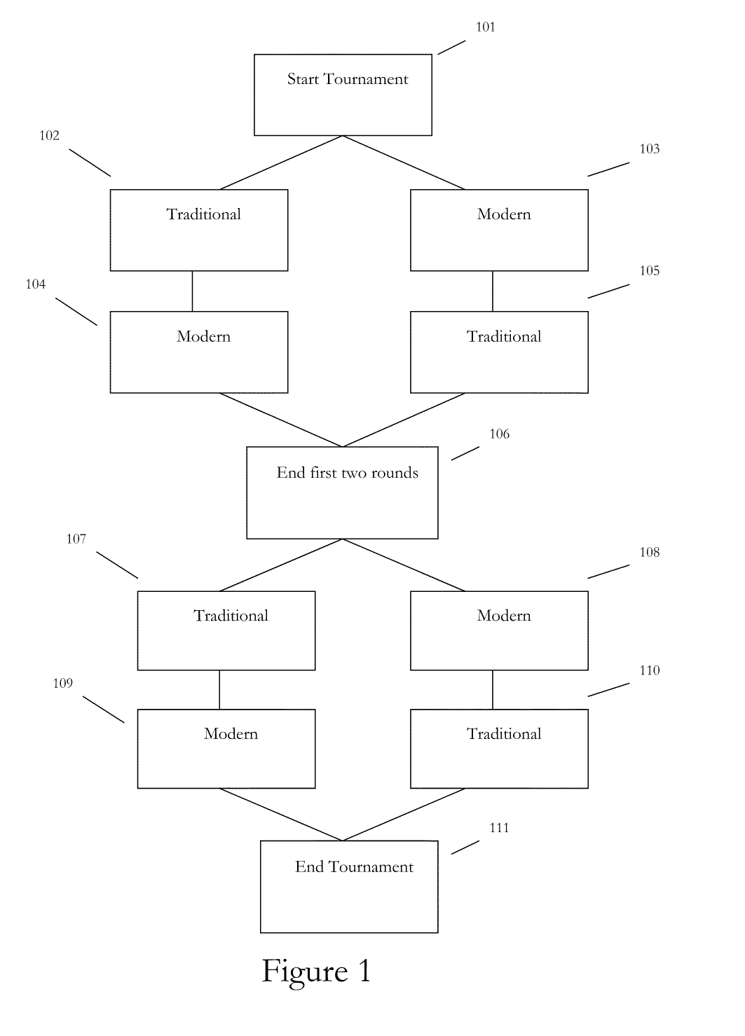

Referring to FIG. 1, a player could follow the following flow. At the start of a tournament 101 a player would select between playing the first round using traditional 102 or modern 103 clubs. Having made that choice a player on their second round would if they had played with traditional 102 clubs, use modern 104 clubs for their second round. A player who used modern 103 clubs for their first round would use traditional 105 clubs for their second round.

At the end of the first two rounds 106 the cut would be made, if applicable. At the start of the third round a player would select between playing the third round using traditional 107 or modern clubs 108. Having made that choice a player on their fourth and final round would if they had played with traditional 107 clubs use modern 109 clubs for their final round. A player who used modern 108 clubs for their third round would use traditional 110 clubs for their final round.

The tournament organisers may deviate from the flow illustrated in FIG. 1. The organisers may specify the clubs or balls for individual rounds or leave it up to the players to select the rounds to use the combinations on. It is further envisaged that the organisers may specify a round that a certain combination must be used but require the players in at least one of the other three rounds to use a specified combination.

The present invention envisages that for at least one round of the tournament players would use traditional clubs and or limited balls. All that is necessary is that either traditional clubs or limited balls are used for at least one round. As will be appreciated, there are a number of combinations possible.

As can be seen in Table 1 for each round there are four combinations possible. The present invention envisages that for at least one round, there would be only three combinations possible. During at least one round, the use of modern clubs and technologically advanced balls would be prohibited. As previously mentioned the organisers may specify the round or allow the players to select from a number of rounds to use the specified combination.

TABLE 1

| | Limited | Technologically |
|---|---|---|
| | Balls | Advanced Balls |
| Traditional | X | X |
| Clubs | | |
| Modern Clubs | X | X |

The winner would be scored using traditional scoring methods.

As previously discussed, using a combination of old style and new style balls could also be incorporated into the tournament. As a alternative instead of or in addition to using old and new style clubs players could be required to use old style balls for one or more rounds and be allowed to use new or modern balls for other rounds. In an alternative, the tees that players tee off from could depend on the clubs or ball type that they are playing a particular round with. A number of variations are possible to make the game more interesting and decrease the reliance of player power and increase the effect on other player skills on the tournament result.

In one embodiment of the present invention the tournament of the present invention would be organised by a computer programmed to decide on the combination of balls and clubs a player is able to use in each of one or more specific rounds. Whenever a player is given a free choice of combination such a choice would be recorded by the computer system. In a further alternative the computer could be programmed to randomly choose which combination each player is use during each round. The random choice can preferable be influenced by input from the tournament organisers as to the parameters the computer is to select from.

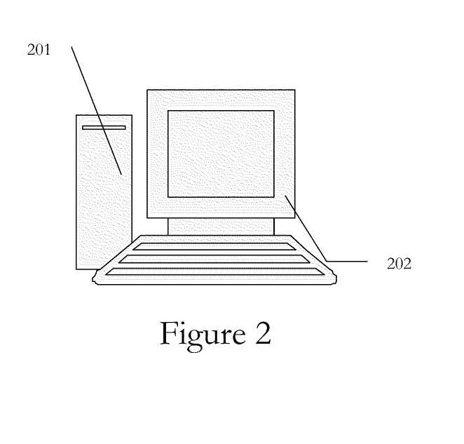

A personal computer 1 as illustrated in FIG. 2 could be suitably programmed to implement the present invention. Input could be provide by any number of input devices including but not limited to a keyboard.

What I claim:

1. A method for organising a golf tournament comprising the steps of:
specifying a first set of clubs for use in the tournament, said first set of clubs being designated traditional clubs; and
requiring each player to use said first set of clubs in at least one round of the tournament;
wherein in other rounds of the tournament each player can choose the golf clubs to use within the rules of golf.

2. The method for organising a golf tournament of claim 1 wherein the step of requiring each player to use said first set of clubs in at least one round of the tournament requires the player to use the first set of clubs in at least two rounds of said tournament.

3. The method for organising a golf tournament of claim 1 including the step of:
requiring each player to use said first set of clubs in one round of the first two rounds of the tournament and one round of the third and fourth rounds of the tournament.

4. The method for organising a golf tournament of claim 1 including the step of:
requiring each player during the tournament to use a first specified ball for a least one round of the tournament, said specified ball being of a limited nature.

5. The method for organising a golf tournament of claim 1 including the step of:
requiring each player during the tournament to use said first ball when using said first clubs.

6. The method for organising a golf tournament of claim 1 including the step of:
requiring each player during the tournament to use said first ball when not using said first clubs.

7. The method for organising a golf tournament of claim 1 including the step of:
requiring each player during the tournament to use balls of a type other than said first ball when not using said first clubs.

8. The method for organising a golf tournament of claim 4 wherein the combination of balls and clubs are specified for at least one of the rounds of the tournament (the specified combination).

9. The method for organising a golf tournament of claim 8 wherein the choice of at least one round to use said specified combination is left to the player.

10. The method for organising a golf tournament of claim 8 wherein the specified combination is played in a specified round.

11. The method for organising a golf tournament of claim 8 wherein the choice of the at least one round to use said specified combination is selected from a specified plurality of rounds.

12. The method for organising a golf tournament of claim 8 wherein there is more than one specified combination; each said combination required to be used for a specified number of rounds.

13. The method for organising a golf tournament of claim 1 wherein each said player tees off a first set of tees when using said first clubs and a second set of tees when using other clubs, said first set of tees resulting in shorter holes.

14. The method for organising a golf tournament of claim 1 wherein only one set of tees would be used.

15. The method for organising a golf tournament of claim 8 wherein each said player tees off a first set of tees when using said first clubs and a second set of tees when using other clubs, said first set of tees resulting in shorter holes.

16. The method for organising a golf tournament of claim 8 wherein only one set of tees would be used.

17. A method for organising a golf tournament comprising the steps of:
specifying a first set of balls for use in the tournament, said first set of balls being designated limited balls; and
requiring each player to use said first set of balls in at least one round of the tournament;
wherein in other rounds of the tournament each player can choose the golf balls to use within the rules of golf.

18. A computer programmed to organise a golf tournament, said computer programmed to: decide on the combination of clubs and ball each player is to use in each round of said tournament, said clubs being selected from those designated traditional clubs; and those designated modern clubs, said ball being selected from those designated limited balls and modern style balls.

19. The computer of claim 18 additionally programmed to decide on the tee each player is to tee of from during each round of said tournament.
